(19) United States
(12) Patent Application Publication
(10) Pub. No.: US 2018/0142693 A1
(43) Pub. Date: May 24, 2018

(54) BLOWER ASSEMBLY FOR A VEHICLE

(71) Applicant: FORD GLOBAL TECHNOLOGIES, LLC, Dearborn, MI (US)

(72) Inventors: Robert Steven Sawyer, Farmington Hills, MI (US); Michael Steven Wallis, Belleville, MI (US)

(21) Appl. No.: 15/358,826

(22) Filed: Nov. 22, 2016

(51) Int. Cl. F04D 29/08; F04D 17/16; F04D 29/42; F04D 27/00; F04D 29/28; F04D 29/66; B60H 1/00

(52) U.S. Cl. CPC F04D 29/083; F04D 17/16; F04D 29/4233; F04D 27/003; B60H 2001/00635; F04D 29/663; B60H 1/00471; B60H 2001/006; F04D 29/281

(57) ABSTRACT

A blower assembly includes a housing having an air inlet side and a scrolled wall, a motor having an output shaft extending within the housing, and an airflow outlet. A wheel is mounted to the output shaft for rotation within the housing and has a plurality of blades for creating an airflow along the scrolled wall. An inlet ring is supported by the air inlet side of the housing and includes a labyrinth seal portion to limit recirculation of air from the airflow. The labyrinth seal portion has an exterior surface along which ambient air entering the housing flows from a proximal end to a distal end, and a guide extends from the exterior surface downstream of the proximal end. The labyrinth seal portion may be hook shaped or otherwise dimensioned to the blade tip. The guide may extend from the distal end or from the exterior surface along a portion of the inlet ring. In another embodiment, the exterior surface of the labyrinth seal portion and an exterior surface of the guide may form a smooth curve.

### TECHNICAL FIELD

This document relates generally to blower assemblies used in a vehicle, and more specifically to inlet rings used in such assemblies to reduce tonal noise.

### BACKGROUND

Blower assemblies are a common component of vehicle HVAC systems and are designed for maximum efficiency/airflow. As shown generally in FIG. 1, a blower assembly 10 is known to include a housing 12 including a scrolled wall 14 and side walls 16, 18. A blower wheel 20 positioned within the housing 12 includes a plurality of blades 22 and is mounted on an output shaft 24 of a motor 26.

In operation, the motor 26 rotates output shaft 24 which in turn rotates the blower wheel 20 and blades 22. Ambient air is drawn through an inlet of side wall 16 and across the plurality of blades 22 creating an internal airflow. The airflow includes an ambient airflow entering the housing 12 across an inlet ring 30 and an internal airflow (generally shown by arrows 28) within the housing 12. The internal airflow 28 travels from the blower wheel blades 22 through an air gap adjacent a scroll cut-off 31 within an airflow path. The internal airflow 28 continues around the scrolled wall 14 of the housing 12 before exiting the housing at an airflow outlet or vent 32.

As suggested above, the blower assembly 10 further includes an inlet ring 30 attached to the housing 12. The inlet ring 30, shown in cross section in FIG. 2, includes a labyrinth seal portion 34 to limit recirculation of the internal airflow 28. As is known in the art, the labyrinth seal 34 is dimensioned to tips 36 of the blower wheel blades 22 creating a mechanical seal in the form of a tortuous path designed to prevent recirculation of the internal airflow 28. An exterior surface 40 of the labyrinth seal 34 further directs the ambient airflow entering the housing 12 (generally shown by arrows 42) past the blade tips 36 from a proximal end 44 to a distal end 46 before entering the housing.

As best portrayed in FIG. 3, the ambient airflow entering the housing 12 impinges on the tips 36 of the blower wheel blades 22 at a high concentration and at a certain angle. At this angle, the airflow includes an axial component (generally parallel with the blade) and a radial component (generally perpendicular to the blade). The axial component of the airflow tends to impinge on the tips 36 of the blower wheel blades 22 causing unwanted vibration and noise, including tonal noise, which is enhanced by the high concentration of ambient air adjacent the blade tips.

In an effort to reduce the unwanted vibration and noise associated with the above-described blower assembly 10, an air block 48 extending substantially vertically from the proximal end 44 of the exterior surface 40 of the labyrinth seal 34 was added to the inlet ring 30 as shown in FIG. 4. The air block 48 is designed to interfere with or alter the ambient airflow along the exterior surface 40 of the labyrinth seal 34 before being drawn into the inlet of side wall 16. This alteration of the ambient airflow is best shown in FIG. 5 wherein the ambient airflow is forced to travel over the air block 48. This lessens the effect of the exterior surface 40 on the ambient airflow compared to the blower assembly without the air block. As a result, a portion of the ambient airflow is directed beyond the blade tips 36 before impinging on the blower wheel blades 22.

In this manner, an amount of the ambient airflow impinging on the blade tips 36 is reduced thereby reducing the unwanted vibration and noise. While successful in reducing some of the noted adverse consequences by directing the portion of the ambient airflow past the blade tips 36, the air block 48 also created eddies of turbulent airflow both immediately downstream of the air block and at the inlet side of the blades 22, i.e., immediately downstream of the distal end 46. These eddies of turbulent airflow themselves create a new axial component of the airflow tending to impinge on the blade tips 36 causing airflow efficiency losses as well as additional potential for unwanted vibration and noise.

In order to further reduce the adverse consequences noted above, the inlet ring should be configured to reduce, if not eliminate, the high concentration of air adjacent the distal end of the labyrinth seal and to distribute the ambient airflow entering the housing more evenly over the length of the fan blades while avoiding the creation of turbulent airflow. More specifically, the inlet ring should be configured to be more efficient by providing an external surface along which ambient air can remain connected or attached for a longer period of time. The external surface should also provide smooth transitions for the air to adhere to in order to avoid creating eddies of turbulent air, and the distal end of the external surface (also known as the airflow separation point) should be located a greater distance from the fan blades than a distal end designed solely to act as part of the labyrinth seal.

### SUMMARY

In accordance with the purposes and benefits described herein, a blower assembly is provided. The blower assembly may be broadly described as including a housing having an air inlet side and a scrolled wall, a motor having an output shaft extending within the housing, and an airflow outlet. A wheel is mounted to the output shaft for rotation within the housing and has a plurality of blades for creating an airflow along the scrolled wall. An inlet ring extends from the air inlet side of the housing and includes a labyrinth seal portion to limit recirculation of air from the airflow. The labyrinth seal portion has an exterior surface along which ambient air entering the housing flows from a proximal end to a distal end, and a guide extends from the exterior surface downstream of the proximal end.

In one possible embodiment, the labyrinth seal portion is hook shaped. In another possible embodiment, the motor is positioned within the housing.

In one other possible embodiment, the guide extends from the distal end. In still another possible embodiment, the guide extends from the exterior surface along a portion of the inlet ring.

In one additional possible embodiment, the exterior surface of the labyrinth seal portion and an exterior surface of the guide form a smooth curve.

In accordance with an additional aspect, a blower assembly includes a housing having an air inlet side and a scrolled wall, a motor having an output shaft extending within the housing, a wheel mounted to the output shaft for rotation within the housing, the wheel having a plurality of blades for creating an airflow along the scrolled wall, an inlet ring supported by the air inlet side of the housing, the inlet ring having a labyrinth seal portion to limit recirculation of air from the airflow, the labyrinth seal portion having a first control surface along which ambient air entering the housing flows to a second control surface extending from the inlet ring for receiving and guiding the ambient air flow, and an airflow outlet.

In still another possible embodiment, the second control surface extends from the distal end. In one additional possible embodiment, the second control surface extends from the first control surface along a portion of the inlet ring.

In yet another possible embodiment, the first control surface and the second control surface form a smooth curve.

In other possible embodiments, the blower assemblies described above are incorporated into a vehicle.

In accordance with another aspect, a method of controlling air or other fluid entering a blower assembly is provided. The method may be broadly described as comprising the steps of: (a) creating an airflow using an impeller positioned within a housing having a scrolled wall; (b) sealing a first portion of the airflow within the housing; (c) guiding a second portion of the airflow outside of the housing using a first control surface along which the first portion of the airflow is drawn from a proximal end towards a distal end and a second control surface extending from the first control surface downstream of the proximal end; and (d) venting the first portion of the airflow.

In another possible embodiment, the first control surface forms part of an inlet ring supported by the housing.

In yet another possible embodiment, the inlet ring includes a labyrinth seal for sealing the first portion of the airflow within the housing.

In still another possible embodiment, the second control surface extends from the distal end of the first control surface. In another, the second control surface extends generally perpendicular to the first control surface at the distal end.

In yet one additional possible embodiment, the first control surface and the second control surface form a smooth curve.

In another possible embodiment, the first control surface forms part of an inlet ring. In still another, the inlet ring includes a labyrinth seal for sealing the first portion of the airflow within the housing.

In the following description, there are shown and described several preferred embodiments of the blower assembly and the related method. As it should be realized, the assemblies and methods are capable of other, different embodiments and their several details are capable of modification in various, obvious aspects all without departing from the assemblies and method as set forth and described in the following claims. Accordingly, the drawings and descriptions should be regarded as illustrative in nature and not as restrictive.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fee.

The accompanying drawing figures incorporated herein and forming a part of the specification, illustrate several aspects of a blower assembly and together with the description serve to explain certain principles thereof. In the drawing figures:

FIG. 1 is a perspective view of a blower assembly;

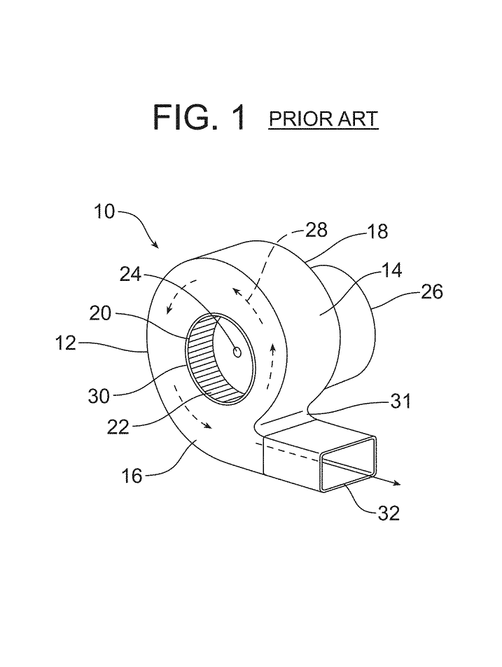

FIG. 2 is a partial cross-sectional view of a fan blade and inlet ring of a prior art blower assembly;

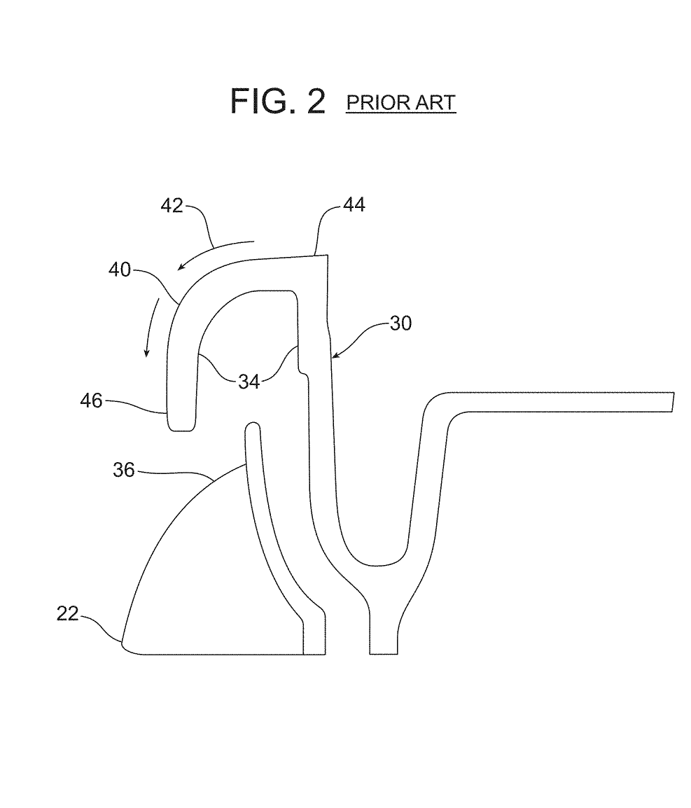

FIG. 3 is a partial cross-sectional view showing a velocity of the ambient air around the fan blade and inlet ring of the prior art blower assembly;

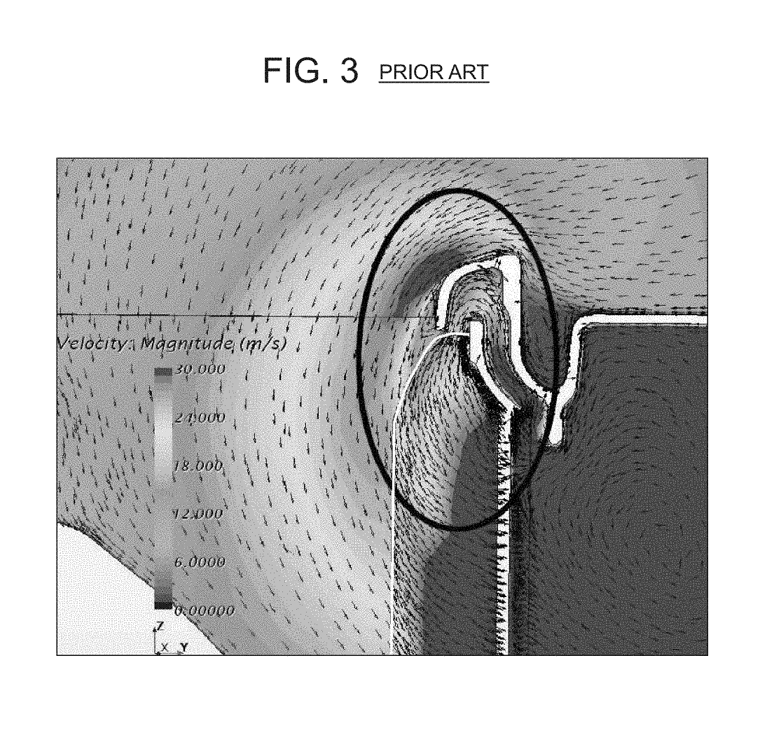

FIG. 4 is a partial cross-sectional view of a fan blade and inlet ring of the prior art blower assembly having an air block extending from the inlet ring;

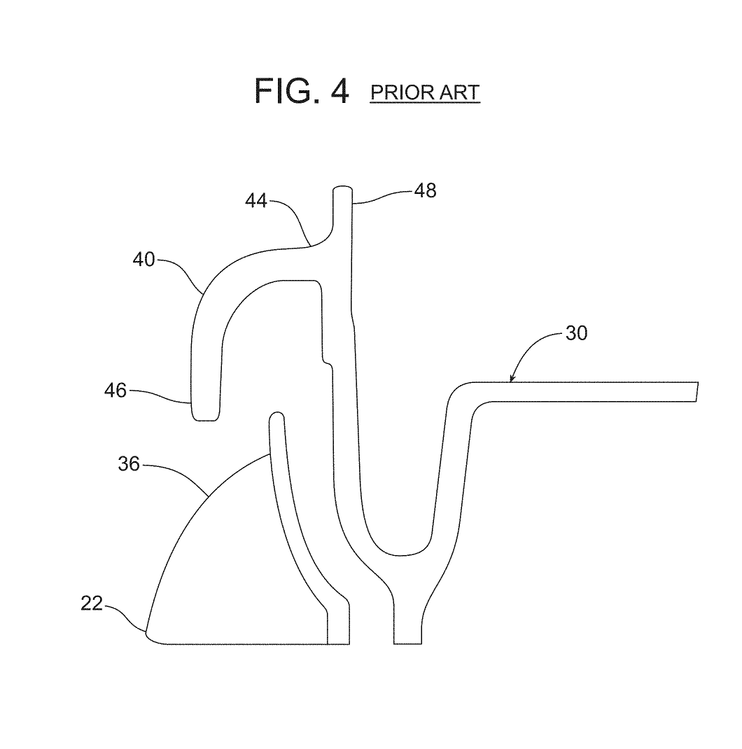

FIG. 5 is a partial cross-sectional view showing a velocity of the ambient air around the fan blade and inlet ring of the prior art blower assembly having an air block extending from the inlet ring;

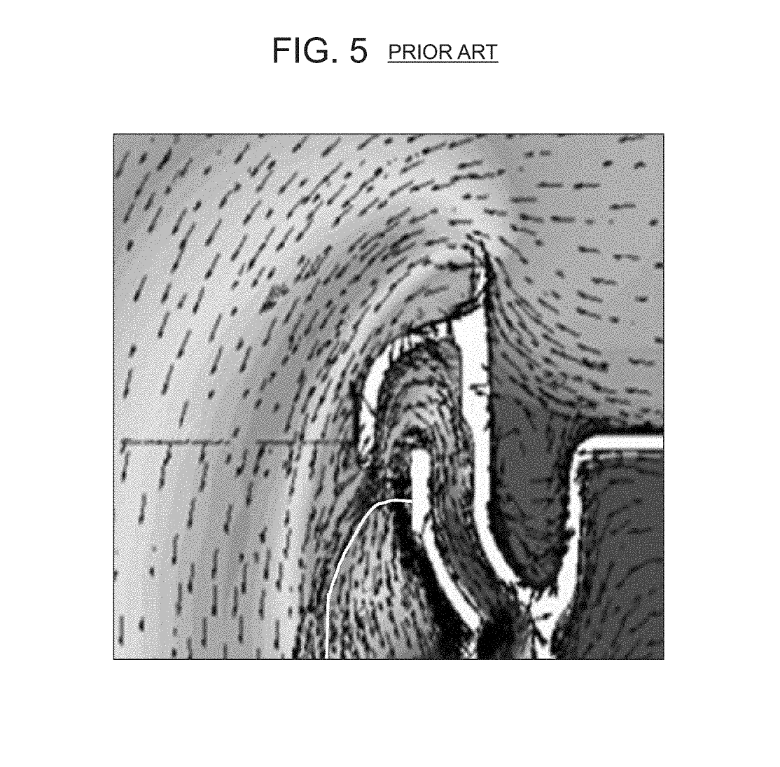

FIG. 6 is a perspective view of a blower assembly;

FIG. 7 is a partial cross-sectional view of a fan blade, inlet ring, and guide extending from an inlet ring of the blower assembly;

FIG. 8 is a partial cross-sectional view of a fan blade, inlet ring, and guide extending from an external surface of an inlet ring of an alternate embodiment of a blower assembly; and

FIG. 9 is a partial cross-sectional view of a fan blade, inlet ring, and guide extending from an external surface of an inlet ring of an alternate embodiment of a blower assembly.

Reference will now be made in detail to the present embodiments of the blower assembly and the related method, examples of which are illustrated in the accompanying drawing figures, wherein like numerals are used to represent like elements.

### DETAILED DESCRIPTION

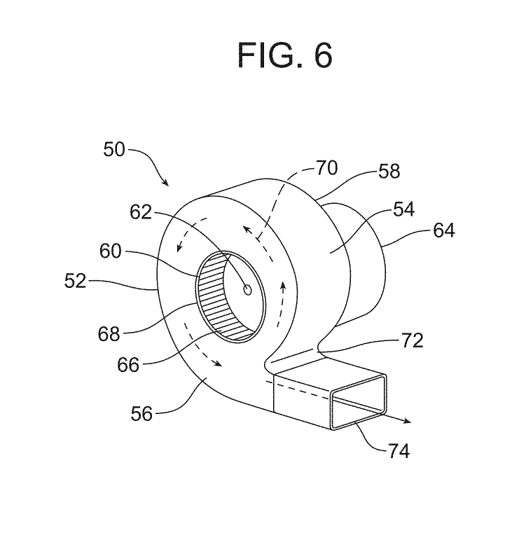

Reference is now made to FIG. 6 which broadly illustrates an embodiment of a blower assembly 50 having a housing 52 including a scrolled wall 54 and side walls 56, 58. The housing 52 is made of suitable rigid plastic materials in the present embodiment, such as, polypropylene or the like through injection, blow molded, etc. Stamped metal components could likewise be used however. A wheel or impeller 60 is positioned within the housing 52 and mounted on an output shaft 62 of a motor 64. Air is drawn into the wheel 60 through an aperture in side wall 56. As shown, the motor 64 in the present embodiment is mounted to the housing 52 and output shaft 62 extends into the housing where the wheel 60 is mounted. In one possible embodiment, the motor may be mounted within the housing and may even be positioned within the shaft that rotates the wheel, in order to limit the footprint of the blower assembly.

In operation, the motor 64 rotates output shaft 62 which in turn rotates the wheel 60 and a plurality of blades 66. Ambient air is drawn through an inlet of side wall 56 and across the plurality of blades 66 creating an airflow. The airflow includes an ambient airflow entering the housing 52 across an inlet ring 68 and an internal airflow (generally shown by arrows 70) within the housing. The internal airflow 70 travels from the blower wheel blades 66 through an air gap adjacent a scroll cut-off 72 within the airflow path. The internal airflow 70 continues around the scrolled wall 54 of the housing 52 before exiting the housing at an airflow outlet 74. The airflow outlet 74 may be attached to the housing 52, or may be integrally molded with the housing.

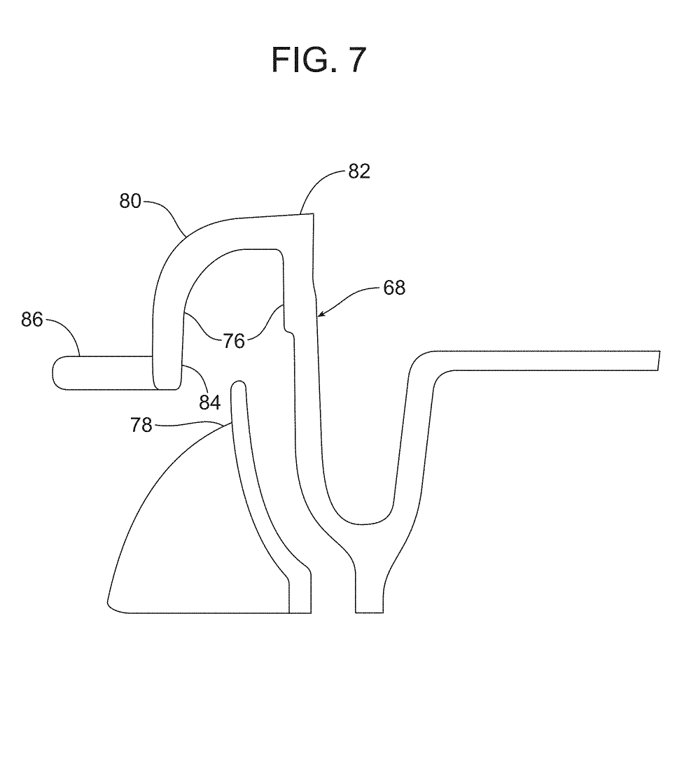

The presently described inlet ring 68 extends from or is otherwise attached to the housing 52 and may be integrally molded in one embodiment. The inlet ring 68, shown in cross section in FIG. 7, includes a labyrinth seal 76 to limit recirculation of the internal airflow 70. As is known in the art, the labyrinth seal 76 is dimensioned to tips 78 of the blower wheel blades 66 creating a mechanical seal in the form of a tortuous path designed to prevent recirculation of the internal airflow 70. An exterior surface 80 of the labyrinth seal 76 further directs the ambient airflow entering the housing 52 past the blade tips 78 from a proximal end 82 past a distal end 84 before entering the housing. As further shown, a guide 86 extends from the external surface 80 of the labyrinth seal 76 downstream of the proximal end 82. More specifically, the guide 86 extends substantially perpendicular from the distal end 84 of the labyrinth seal 76. The guide 86 may be separately formed and attached to the inlet ring 68 or integrally formed (e.g., by molding).

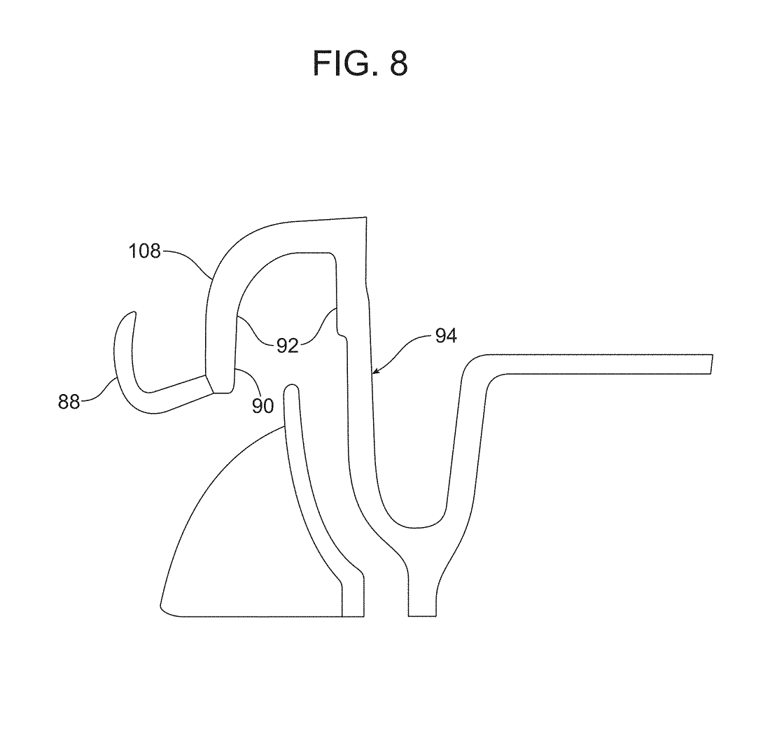

In an alternate embodiment shown in FIG. 8, a guide 88 is generally hook-shaped or J-shaped and extends from a distal end 90 of a labyrinth seal 92. Again, the guide 88 may be separately formed and attached to an inlet ring 94 or integrally formed (e.g., by molding).

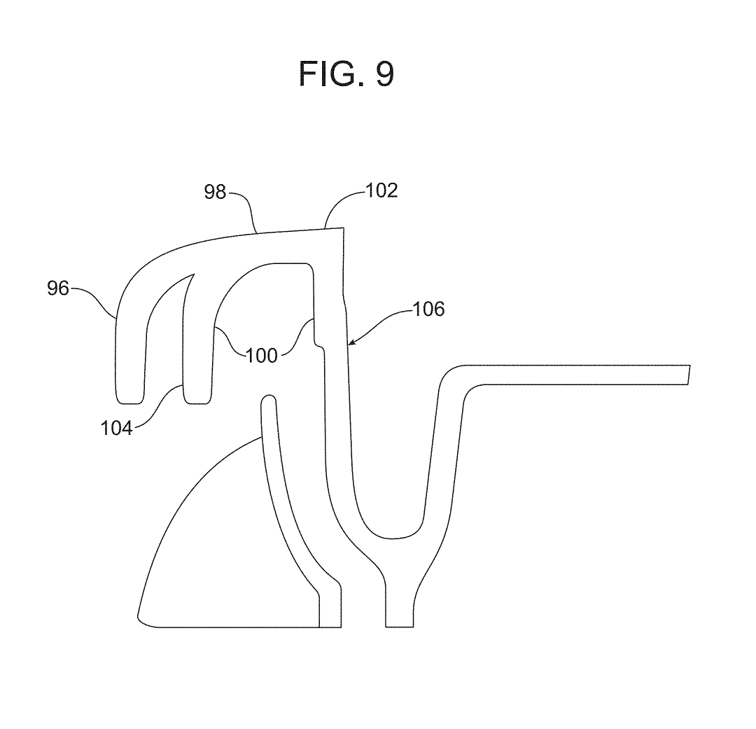

In still another alternate embodiment shown in FIG. 9, a guide 96 extends from an external surface 98 of a labyrinth seal 100 downstream of a proximal end 102. More specifically, the guide 96 extends laterally and inwardly from a position between the proximal end 102 and a distal end 104. While the guide 96 extends generally from a midpoint of the external surface 98, the location of the guide can fall anywhere between the proximal and distal ends 102 and 104 in still other embodiments. Again, the guide 96 may be separately formed and attached to an inlet ring 106 or integrally formed (e.g., by molding).

In another aspect of the invention, a method of controlling an airflow entering a blower assembly 50 includes the steps of creating an airflow using wheel blades 66 positioned within a housing 52 having a scrolled wall 54, sealing a first portion of the airflow within the housing, and guiding a second portion of the airflow outside of the housing using a first control surface 80 along which the first portion of the airflow is drawn from a proximal end 82 towards a distal end 84 and a second control surface 86 extending from the first control surface downstream of the proximal end, and venting the first portion of the airflow.

As described in greater detail above, the airflow is created by driving the blades 66 with a motor 64 such that the blades rotate creating a flow of air within the housing 52. The first portion of the airflow is sealed within the housing by a labyrinth seal 76 forming a part of an inlet ring 68. The labyrinth seal 76 is shaped to the tips 78 of the blades 66. The first control surface 80 used to guide the second portion of the airflow from the proximal end 82 towards the distal end 84 forms a portion of the labyrinth seal 76 in the described embodiment. The second control surface 86 extends from the first control surface 80 downstream of the proximal end 82 and further guides the second portion of the airflow outside of the housing 52. In the described embodiments, the first control surface 80 forms part of the inlet ring 68 and the second control surface 86 extends from the distal end 84 of the first control surface. In the presently described embodiment, the second control surface 86 extends generally perpendicular to a distal portion of the first control surface 80. In an alternate embodiment reflected in FIG. 8, the second control surface 88 extends from the distal end 90 of a first control surface 108. Similarly, another alternate embodiment reflected in FIG. 9 includes a second control surface 96 that extends from a first control surface 98 downstream of a proximal end 102.

In summary, numerous benefits result from providing a blower assembly having an inlet ring configured to reduce, if not eliminate, the high concentration of air adjacent the distal end of the labyrinth seal and to distribute the ambient airflow entering the housing more evenly over the length of the fan blades while avoiding the creation of turbulent airflow. As shown, the inlet ring is configured to be more efficient by providing an external surface along which ambient air can remain connected or attached for a longer period of time. The external surface also provides smooth transitions for the air to adhere to in order to avoid creating eddies of turbulent air, and the distal end of the external surface (also known as the airflow separation point) is located a greater distance from the fan blades than a distal end designed solely to act as part of the labyrinth seal.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A blower assembly, comprising:
a housing having an air inlet side and a scrolled wall;
a motor having an output shaft extending within said housing;
a wheel mounted to said output shaft for rotation within said housing, said wheel having a plurality of blades for creating an airflow along said scrolled wall;
an inlet ring extending from said air inlet side of said housing, said inlet ring having a labyrinth seal portion to limit recirculation of air from the airflow, said labyrinth seal portion having an exterior surface along which ambient air entering said housing flows from a proximal end to a distal end, and a guide extending from said exterior surface downstream of said proximal end; and
an airflow outlet.

2. The blower assembly of claim 1, wherein said labyrinth seal portion is hook shaped.

3. The blower assembly of claim 1, wherein said motor is positioned within said housing.

4. The blower assembly of claim 1, wherein said guide extends from said distal end.

5. The blower assembly of claim 1, wherein said guide extends from said exterior surface along a portion of said inlet ring.

6. The blower assembly of claim 1, wherein said exterior surface of said labyrinth seal portion and an exterior surface of said guide form a smooth curve.

7. A blower assembly, comprising:
a housing having an air inlet side and a scrolled wall;
a motor having an output shaft extending within said housing;
a wheel mounted to said output shaft for rotation within said housing, said wheel having a plurality of blades for creating an airflow along said scrolled wall;
an inlet ring supported by said air inlet side of said housing, said inlet ring having a labyrinth seal portion to limit recirculation of air from the airflow, said labyrinth seal portion having a first control surface along which ambient air entering said housing flows to a second control surface extending from said inlet ring for receiving and guiding the ambient air flow; and
an airflow outlet.

8. The blower assembly of claim 7, wherein said labyrinth seal portion is hook shaped.

9. The blower assembly of claim 7, wherein said motor is positioned within said housing.

10. The blower assembly of claim 7, wherein said second control surface extends from a distal end of said first control surface.

11. The blower assembly of claim 7, wherein said second control surface extends from said first control surface along a portion of said inlet ring.

12. The blower assembly of claim 11, wherein said first control surface and said second control surface form a smooth curve.

13. A method of controlling air entering a blower assembly comprising the steps of:
creating an airflow using an impeller positioned within a housing having a scrolled wall;
sealing a first portion of the airflow within said housing;
guiding a second portion of the airflow outside of said housing using a first control surface along which the first portion of the airflow is drawn from a proximal end towards a distal end and a second control surface extending from said first control surface downstream of said proximal end; and
venting said first portion of the airflow.

14. The method of controlling air entering a blower assembly of claim 13, wherein said first control surface forms part of an inlet ring supported by said housing.

15. The method of controlling air entering a blower assembly of claim 14, wherein said inlet ring includes a labyrinth seal for sealing the first portion of the airflow within said housing.

16. The method of controlling air entering a blower assembly of claim 13, wherein said second control surface extends from said distal end of said first control surface.

17. The method of controlling air entering a blower assembly of claim 16, wherein said second control surface extends generally perpendicular to said first control surface at said distal end.

18. The method of controlling air entering a blower assembly of claim 13, wherein said first control surface and said second control surface form a smooth curve.

19. The method of controlling air entering a blower assembly of claim 18, wherein said first control surface forms part of an inlet ring.

20. The method of controlling air entering a blower assembly of claim 19, wherein said inlet ring includes a labyrinth seal for sealing the first portion of the airflow within said housing.
